(19) United States
(12) Patent Application Publication
(10) Pub. No.: US 2017/0021267 A1
(43) Pub. Date: Jan. 26, 2017

(54) Lucky Sweeper

(71) Applicant: Adam Kessinger, Monterey Park, CA (US)

(72) Inventor: Adam Kessinger, Monterey Park, CA (US)

(21) Appl. No.: 14/806,772

(22) Filed: Jul. 23, 2015

(51) Int. Cl. A63F 3/06; A47L 5/26; B44D 3/16

(52) U.S. Cl. CPC A63F 3/068; B44D 3/162; A47L 5/26

(57) ABSTRACT

Disclosed herein is a battery operated vacuum scratch device that is small, powerful, handheld and cylindrical shaped primarily for use when scratching off and cleaning up the scrapings left behind from a “scratch-off” lottery cards. Activated by a power switch and battery, the vacuum scratch device comprises of a blade for scratching, along with a holding arrangement for holding a coin providing an alternate option for scratching, a catch-mouth suction of the debris, a light source, a grip on its body, battery compartment, a motor, a fan, an external vented port, a removable scratch card debris catch tray. The device becomes a scraping device through use of the scraper blade or coin mechanism which is affixed to one end of the unit near the vacuum accessory piece.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

(1) Field of the Invention

The present invention relates to new and improved lottery card scratcher device having a vacuum battery operated system, and more specifically, this invention relates to a hand held device enabling the surface of a lottery cards to be removed by incorporating a blade and a coin into the body of the invented device.

(2) Background of Invention

This disclosure generally relates to the field of gaming. More particularly, the disclosure relates to wagering for a game.

A lottery is generally a distribution of tokens such that a subset of the distributed tokens may win a prize. The token can be in the form of a ticket. One of the most popular forms of lottery involves the distribution of lottery tickets. Each lottery ticket includes a lottery number. After the lottery tickets have been distributed to the lottery ticket holders, the winning number is chosen. The usual method of selecting the winning number involves a random selection of the winning number. A random number generator can be used to randomly select the winning number. Some lottery systems require the ticket to have the entire number that is randomly selected while other lottery systems require the ticket to have a subset of an ordered sequence of numbers that are randomly selected.

The “scratch tickets” are covered with a layer, or layers, of opaque materials which hide text printed on the surface of the ticket which tells the player whether or not he or she has won. The surface is scratched off by the player in a variety of ways, including fingernails, knives, and coins. The surface layers are generally of such a nature that they yield to such methods of removal.

In the related art, portable hand held and battery powered vacuum appliances are well known and widely available. Typically of portable hand held vacuums currently available is that disclosed in U.S. Pat. No. 5,025,529 and U.S. Pat. No. 4,993,106 and U.S. Pat. No. 4,920,608, all issued in the name of HuIt et at As is generally the case, such appliances are general purpose cleaning tools, and function in a manner similar to their larger, full sized equivalents. Also known are specialty vacuum tools such as the battery operated hand held vacuum handling device as disclosed in U.S. Pat. No. 5,290,082, issued in the name of Palmer et al. As disclosed in the Palmer et al. reference, such a device is intended for use in grasping and moving light weight objects.

A particular problem is associated with the proliferation of instant lottery tickets. These “scratch-off” type of instant lottery tickets have become widely available, and generally result in debris resulting from removal of the opaque scraped material used to block the identifying information of such lottery tickets. And, although such general purpose portable vacuum devices can be used to remove such debris, such a use is rarely convenient or practical. Consequently, a need has been felt for providing an apparatus and method which can easily and portably, aid a user in scraping material from the surface of an instant lottery ticket while at the same time providing a means of cleaning up the debris left by such scrapings.

### BRIEF SUMMARY OF THE INVENTION

The present invention is directed to a combination of vacuum and lottery card scraper apparatus.

It is a feature of the present invention to provide an improved hand held device which provides a scraper means for scraping type lottery cards while simultaneously providing a vacuum means for removing the debris caused by such scrapings.

In accordance with a preferred embodiment the present ,invention is most obviously beneficial for quick cleanups, but not limited to lottery cards scrapings.

As described above, the functional pocket size of the unit and the handy feature of the preferred embodiment of the present invention make transport easy, and the scraper blade ends and the coin, most frequently used for uncovering lottery numbers.

Other features and advantages of the present invention will become more apparent from the following detailed description, taken in conjunction with the accompanying drawings which illustrate, by way of example, the principles of the invention.

### BRIEF DESCRIPTION OF THE SEVERAL VIEWS OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is a diagram illustrating the combination of vacuum and lottery card scraper apparatus.

### DETAILED DESCRIPTION OF THE INVENTION

The following detailed description refers to the accompanying drawings that illustrate the embodiments of the present invention. Other embodiments are possible and modifications may be made to the embodiments without departing from the spirit and scope of the invention. Therefore, the following detailed description is not meant to limit the invention. Rather the scope of the invention is defined by the appended claims.

A lottery is a form of gambling which involves the drawing of lots for a prize. One extremely common, easy-to-play alternative to the traditional lottery card is the scratch-off. The tool which is used for scratching the lottery cards is called a scratch tool.

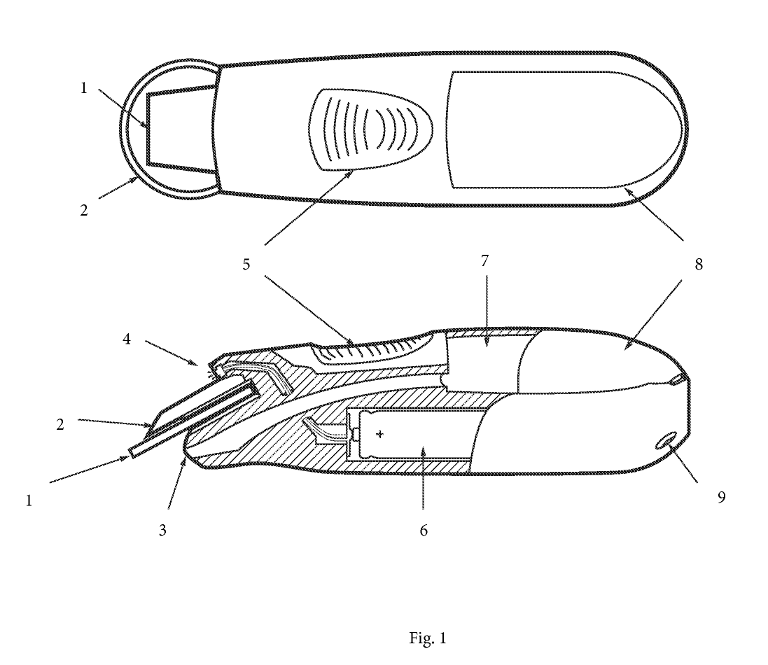

With reference to the accompanying figures, various embodiments of a vacuum battery operated scratch device with light will be described. FIG. 1 of the drawings includes a vacuum battery operated scratch device that is small, powerful and handheld, having a blade for scratching 1, placed adjacent to a holding arrangement for holding a coin 2, a catch-mouth for suction 3 of the debris created of the scratching of the opaque film or coating but the coin or the blade, a light source 4 (i.e., with one or more lighting elements) is positioned to provide light for convenient scratching of a lottery ticket, or any scratching portion thereof, in order to see where to scratch, as well as the numbers or other indicia under the opaque coating that is scratched off. The light source can also be used as a tiny flashlight. A grip 5 on the device body imposes a scratching action on a lottery ticket of sufficient pressure to scratch off an opaque film or coating on the substrate of the ticket. The grip's dimensions are equvalent to a size of a person's finger tip to make comfortable for a person to grip-on. The device also having the battery compartment housing a battery 6 for providing electrical power, a motor, a fan, an external vented port, and a removable scratch card debris catch tray 7 covered with a lid 8. The device also having a hole 9 to insert a keychain.

According to the invention a portable, hand held vacuum apparatus is provided, having a cylindrical-shaped outer housing which supports a combination scraping means blade and coin are present at the front end of the cylindrical-shaped outer housing. The scraping mean blade and coins are envisioned in its preferred embodiment as a scraper blade. A vacuum accessory piece located at the front of the apparatus, and is located in close physical proximity with the scraper means and coins. Additionally, at least one external vented port is provided in communication with the vacuum accessory piece.

Next provided that a battery is also housed within the body of the housing, and is in electrical contact with both the rotating on/off switch as well as the motor in order to provide the necessary electrical energy. A motor also operates within the external vented port such as to provide a means of propelling air from the vacuum accessory piece, along the external vented port, and out the air discharge ports. The vacuum and air flow conveniently removes any debris, and traps the debris in the residue tray, were it can be removed and discarded at a later time.

Further a light system that is also associated with the apparatus. The light can be an LED or an incandescent, neon or fluorescent light bulb, or any other form of light emitting device that can be housed in a hand-held device. The light can, for instance, be a pair of LEDs positioned to be the eyes of a character, and can be activated by any suitable form of switch, such as a slide switch, push switch, a squeeze switch, or by a pressure activated switch activated by engaging the scratching, tool on a surface, or combinations thereof.

Broadly, an embodiment of the present invention provides a tool having a scraping means as blade and coin designed for removing scratch-off coatings, such as those that reveal activation codes on lottery cards, without causing damage to the printing under the scratch-off coating. Unlike conventional objects, such as knives and coins, the tool of the present invention removes only the scratch-off coating without scraping, off the activation code.

It is to be understood that the above description is intended to be illustrative, and not restrictive. For example, the above-discussed embodiments may be used in combination with each other. Many other embodiments will be apparent to those of skill in the art upon reviewing the above description. It is to be understood that the above description is intended to be illustrative, and not restrictive. For example, the above-discussed embodiments may be used in combination with each other. Many other embodiments will be apparent to those of skill in the art upon reviewing the above description.

Plural instances may be provided for components, operations or structures described herein as a single instance. Finally, boundaries between various components are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

I claim:

1. A combination of vacuum and lottery card scraper apparatus comprising:
an elongated, hand held outer housing having a front end and a back end,
a small vacuum accessory piece;
a battery;
a battery compartment;
a coin;
a blade;
a light source;
a motor;
a fan;
a grip;
an external vented port; and
a debris catch tray.

2. The apparatus as described in claim 1, wherein said outer housing is cylindrical in shape.

3. The apparatus as described in claim 1, wherein said vacuum accessory piece is used for hold the coin in place.

4. The apparatus as described in claim 1, wherein said battery housed within said outer housing.

5. The apparatus as described in claim 1, wherein said coin is used for scratch cards.

6. The apparatus as described in claim 1, wherein said blade is used for scratch cards in place of said coin.

7. The apparatus as described in claim 1, wherein said motor is present in order to provide the necessary electrical energy to operate said motor.

8. The apparatus as described in claim 1, wherein said debris catch tray is used for collection of debris released from scratched card.

9. The apparatus as described in claim 1, wherein said grip having dimensions equvavalent to a size of a person's finger tip to make comfortable for a person to grip-on

10. The apparatus as described in claim 1, wherein said light source is a LED light.

11. The apparatus as described in claim 1, wherein said card scraper apparatus further comprises of a keychain holder.
